(19) United States
(12) Patent Application Publication
(10) Pub. No.: US 2021/0293227 A1
(43) Pub. Date: Sep. 23, 2021

(54) HIGH-PRESSURE HOMOGENISER

(71) Applicant: GEA MECHANICAL EQUIPMENT ITALIA S.P.A., 43123 PARMA (IT)

(72) Inventors: MICHELE MANFREDI, PARMA (IT); MASSIMILIANO BENASSI, FORNOVO DI TARO (IT); LEONARDO MAGGI, PARMA (IT); CESARE BANDINI, NOCETO (IT)

(21) Appl. No.: 17/258,417

(22) PCT Filed: Jul. 30, 2019
(86) PCT No.: PCT/IB2019/056483

§ 371 Date: Jan. 6, 2021

(30) Foreign Application Priority Data
Aug. 2, 2018 (IT) 102018000007789
Aug. 2, 2018 (IT) 102018000007790

(51) Int. Cl. F04B 17/03; F04B 1/0408; F04B 1/0421

(52) U.S. Cl. CPC F04B 17/03; F04B 1/0421; F04B 1/0408

(57) ABSTRACT

High-pressure homogeniser (100) comprising:

a volumetric piston pump (1) comprising a plurality of pumping pistons (10);
a homogenising valve (20) arranged downstream of the volumetric piston pump (1); linear motion transmission means (5) of the electro-hydrostatic type, comprising an electric motor (6) and a pump (7) directly driven by the electric motor (6), the pump (7) being operatively active on the pistons (10);
a control unit (40) configured to control the linear motion transmission means (5) such that a reciprocating motion is imposed to each piston (10) according to a law of motion which is pre-established and independent from the laws of motion of the other pistons (10).

### TECHNICAL FIELD

The present invention relates to a high-pressure homogeniser, in particular for use in the dairy sector. The invention can also find use in the chemical or pharmaceutical industry.

### BACKGROUND ART

As is known, the apparatuses for homogenising fluids crush the particles making their dimensions uniform, thereby reducing the average dimension and variance of the distribution of the dimensions of the particles.

These homogenising apparatuses, also in the different embodiments so far known, comprise a high-pressure pump and a homogenising valve.

### DISCLOSURE OF THE INVENTION

Beyond the various solutions available on the market, the high-pressure pump is a volumetric pump with pistons that move with a reciprocating motion through a crankshaft (or camshaft), synchronous and phase-shifted from each other by an angle of 360°/n, where n is the number of pistons.

In accordance with a known solution, the homogenising valve, placed downstream of the piston pump, comprises a first chamber receiving the fluid at high pressure from the pump delivery and a second chamber capable of supplying outgoing homogenised fluid at low pressure. The homogenising action is obtained by forcing the fluid to pass through an interspace with reduced dimensions afforded between the first and the second chamber.

The drive is obtained by means of an electric motor which drives the crankshaft through a gear reducer and a suitable kinematic reduction chain.

Since the crankshaft is realised with fixed relative angles, the phase shift between the pulses of the pistons is also fixed.

Recently, the Applicant has developed a high-pressure homogeniser wherein each piston is associated with a corresponding oleodynamic cylinder, with its hydraulic circuit. An electronic control unit independently regulates the proportional valves of the circuits of each cylinder, imposing a law of motion to the individual pistons.

This solution is described in WO 2014/097075.

From document U.S. Pat. No. 6,827,479 B1 it is known a high-pressure homogeniser having a pair of cylinder pumps that are driven by a hydraulic system comprising two separate, partially duplicated arrangements, one for each cylinder pump. The hydraulic system uses a pair of hydraulic cylinders with a direction control valve in communication with each hydraulic cylinder. The control valves are of the four-way sliding bobbin type having an off position and two opposed direction positions that activate each cylinder in an opposed reciprocating sequence.

In this context, the object of the present invention is to propose a high-pressure homogeniser which further increases the homogenisation efficiency.

Another object of the present invention is to propose a high-pressure homogeniser having a greater degree of flexibility, in terms of flow rate and pressure, as compared to the known solutions.

Another object of the present invention is to propose a high-pressure homogeniser that can be configured and adapted as a function of changing specifications in time, for example for different applications.

Another object of the present invention is to propose a high-pressure homogeniser of easier maintenance with respect to the known solutions.

In totally different sectors, such as the aerospace sector, electro-hydrostatic actuators are known (generally indicated with the acronym EHA), i.e. hydraulic actuators controlled directly by an electric motor-pump system. An example of the use of an EHA actuator is shown in US 2018/0087547 to control the position of aircraft surfaces, such as flaps.

It should be noted that the term “electro-hydrostatic actuator” is used by some manufacturers, such as Moog, while other manufacturers use the term servo-hydraulic actuator (generally indicated with the acronym SHA) or, more generically, hydraulic systems driven by brushless motors.

The stated technical task and specified objects are substantially achieved by a high-pressure homogeniser according to claim 1.

### BRIEF DESCRIPTION OF DRAWINGS

Further characteristics and advantages of the present invention will appear more clearly from the indicative, and therefore non-limiting, description of a preferred but not exclusive embodiment of a high-pressure homogeniser, as illustrated in the drawings, wherein:

FIGS. 1a-1b show a high-pressure homogeniser, according to the present invention, in two different perspective views;

FIGS. 2a-2b schematically show one embodiment of the linear motion transmission means applied to a piston of the homogeniser of FIG. 1a-1b;

FIG. 3 shows the block diagram of a high-pressure homogeniser, according to the present invention;

FIGS. 4 and 5 are flow rate charts, referring respectively to two pumping pistons and three pumping pistons;

FIG. 6 shows part of a stand-alone pumping module, in perspective view, usable in the high-pressure homogeniser, according to the present invention;

FIG. 7 shows the block diagram of a high-pressure homogeniser, according to the present invention, comprising a plurality of stand-alone pumping modules 1.

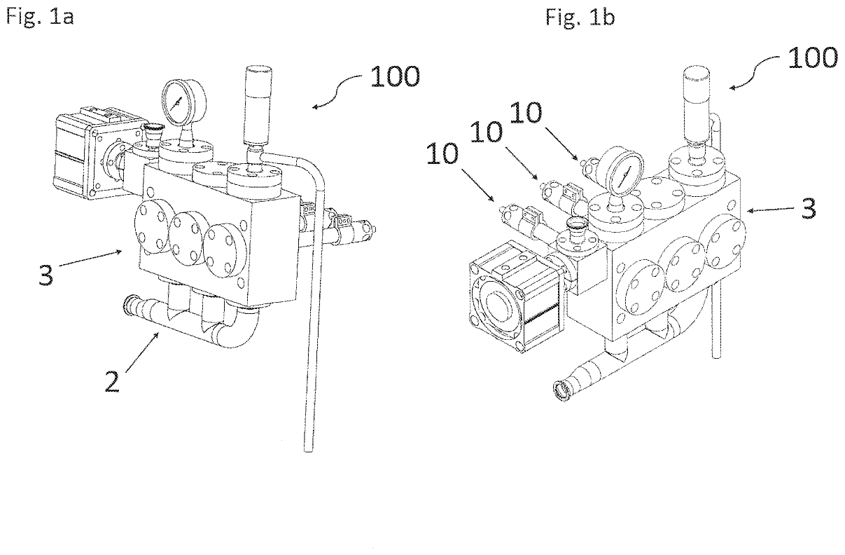

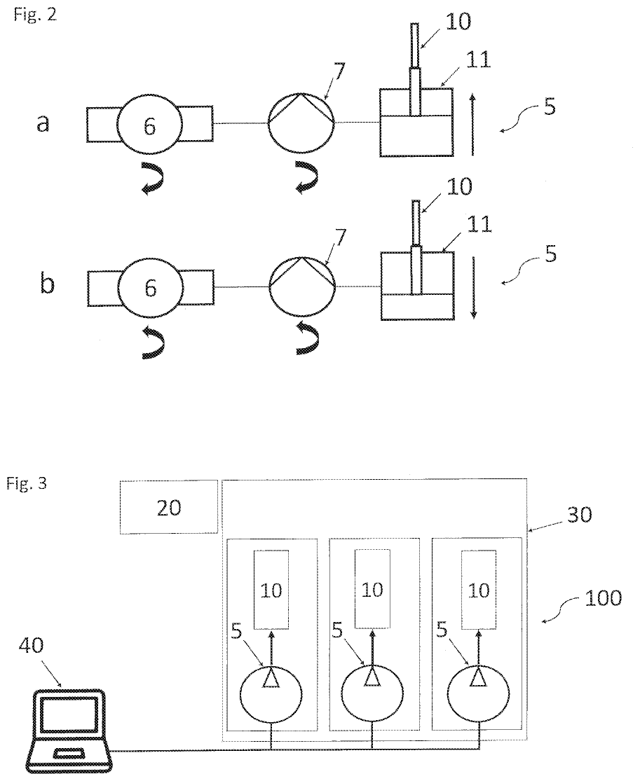

### DETAILED DESCRIPTION OF PREFERRED EMBODIMENTS OF THE INVENTION

With reference to the figures, the number 100 denotes a high-pressure homogeniser comprising:
a volumetric piston pump comprising a plurality of pumping pistons 10;
a homogenising valve 20 arranged downstream of the volumetric piston pump;
linear motion transmission means 5 operatively active on the pistons 10;
a control unit 40 configured to control the linear motion transmission means 5 such that a reciprocating motion is imposed to each piston 10 according to a law of motion which is pre-established and independent from the laws of motion of the other pistons 10.

Linear transmission means is intended as means which controls the pistons through a linear kinematic chain, i.e. means which converts the rotary motion of a motor into linear motion through a mechanical system.

In particular, a corresponding pre-established law of motion is imposed to each piston 10 such that the summation defines a thrust profile at a constant flow rate.

In practice, the control unit 40 is configured to impose on each piston 10 a virtual cam profile independent from the profiles of the other pistons 10. Preferably, the virtual cam profile is established on the basis of product characteristics, pressure, flow rate and any other parameters of interest.

The volumetric piston pump comprises:
an aspirating manifold 2 of a fluid;
a compression head 3, positioned downstream of the aspirating manifold 2, formed by the pistons 10 and by the corresponding oleodynamic cylinders 11;
a delivery manifold of the fluid (not shown), located downstream of the compression head.

The linear motion transmission means 5 is of the electro-hydrostatic type, i.e. it comprises an electric motor 6 and a pump 7 controlled directly by the electric motor 6, which is operatively active on the piston 10.

The electric motor 6 is of the brushless type. The brushless motor 6 puts the pump 7 in rotation which, in response to the type of pulse it receives, can turn in one direction or the other, acting on the piston 10 and thus putting the anterior chamber or the posterior chamber of the corresponding oleodynamic cylinder 11 in pressure.

The electro-hydrostatic transmission means regulates the pressure and flow of oil delivered to the oleodynamic cylinders 11 and thus the thrust and the advancing speed of the corresponding pistons 10 without the need to use proportional valves. This differs from the solution proposed in WO 2014/097075, where there is instead a proportional valve for each oleodynamic cylinder.

The homogenising valve 20 is of the known type and will not be further described.

Preferably, the homogeniser 100 comprises a pressure transducer operatively active on the delivery manifold. The control unit 40 is preferably a feedback control unit configured to correct an inlet set-point pressure as a function of the pressure signal detected by the pressure transducer. The control unit 40 can consist of an electronic module, suitably programmed to perform the functions described, which can correspond to different hardware and/or routine software entities belonging to the programmed module.

Alternatively, or in addition, such functions can be performed by a plurality of distributed electronic modules.

The control unit 40 can further avail itself of one or more processors for executing instructions contained in memory modules.

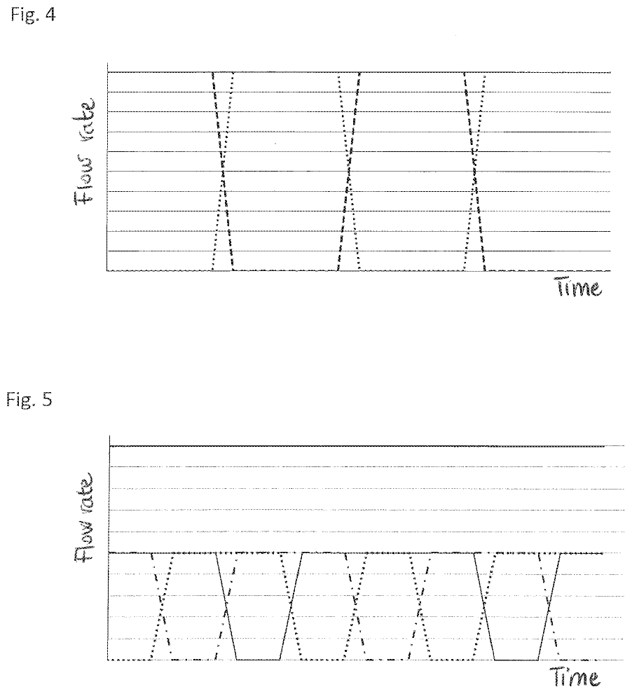

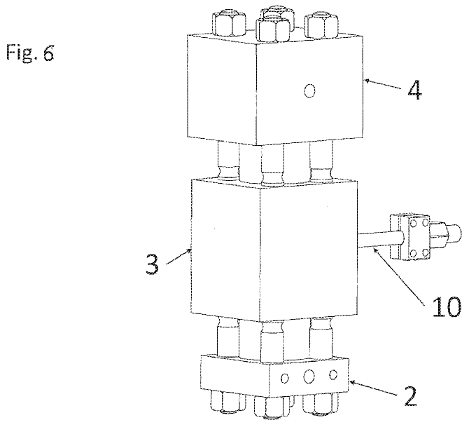

FIGS. 4-5 show the pulse trend of some pistons 10. The flow rate charts are similar to those proposed in the document WO 2014/097075.

FIG. 6 shows an embodiment of the volumetric piston pump. It is part of a stand-alone pumping module, indicated with the number 1, comprising:
an aspirating manifold 2;
a compression head 3;
a delivery manifold 4.

In FIG. 6, the compression head 3 comprises a single piston 10 associated with a corresponding oleodynamic cylinder 11, but it could also comprise multiple pistons 10, each of which is associated with a corresponding oleodynamic cylinder 11 which comprises a corresponding oleodynamic circuit. The piston 10 moves in a reciprocating manner, controlled by linear motion transmission means 5 on the stand-alone pumping module 1.

The linear motion transmission means 5 is of the electro-hydrostatic type, as described above.

The homogeniser 100 can comprise a plurality of identical stand-alone pumping modules 1, while the initial stand-alone pumping module (also called front-end) comprises some additional components.

In particular, the front-end pumping module comprises a manometer and a safety valve.

The laws of motion imposed to the pistons 10 of the stand-alone pumping modules 1 depend on the number and type of pumping modules installed. These laws of motion (i.e. virtual cam profiles) are defined inside a software loaded in the control unit 40. The summation of the laws of motion (in terms of flow rate) defines a thrust profile at a constant flow rate.

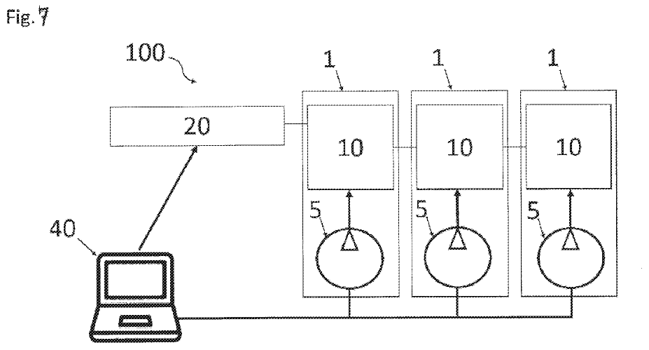

FIG. 7 shows the block diagram of a high-pressure homogeniser 100 comprising a plurality of stand-alone pumping modules 1.

The characteristics of the high-pressure homogeniser according to the present invention emerge clearly from the above description, as do the advantages.

In particular, the homogeniser proposed here is more efficient than the solution proposed in WO 2014/097075 thanks to the use of electro-hydrostatic transmission means.

Furthermore, the stand-alone pumping module with a linear actuator allows high flexibility in terms of production capacity and operating pressure of the homogeniser in which it is used.

In fact, the homogeniser is easily scalable by adding pumping modules designed according to specific needs, which can also change over time. Consider, for example, the need to expand the homogeniser by adding additional pumping modules, in order to respond to changing production needs.

The modular structure also allows simplifying maintenance operations, going from time to time to act directly on the pumping module in which the malfunction has occurred.

In addition, the standardisation of the modules allows responding to customer needs more quickly and effectively: starting from a couple of types of standard modules, combined in a certain number, it is possible to meet any customer request and simplify stock logistics.

1-5. (canceled)

6. High-pressure homogeniser (100) comprising:
a volumetric piston pump (1) comprising a plurality of pumping pistons (10);
an oleodynamic cylinder (11) for each piston (10);
a homogenising valve (20) arranged downstream of said volumetric piston pump (1);
linear motion transmission means (5) operatively active on said pistons (10);
a control unit (40) configured to drive said linear motion transmission means (5) in such a way that each piston (10) is subject to an alternating motion according to a pre-established law of motion that is independent from the laws of motion of the other pistons (10),
characterised in that said linear motion transmission means (5) is an electro-hydrostatic actuator comprising a brushless motor (6) and a pump (7) directly driven according to a clockwise or counter-clockwise rotation direction in response to a pulse received from said brushless motor (6), said pump (7) being operatively active on said pistons (10) and thus putting an anterior chamber or a posterior chamber of the corresponding oleodynamic cylinder (11) in pressure.

7. High-pressure homogeniser (100) according to claim 6, said pre-established law of motion defining a thrust profile at a constant flow rate.
